(19) United States
(12) Patent Application Publication
(10) Pub. No.: US 2026/0211762 A1
(43) Pub. Date: Jul. 23, 2026

(54) ANOMALY DETECTION IN TIME SERIES DATA

(71) Applicants: Disney Enterprises, Inc., Burbank, CA (US); Beijing YoJaJa Software Technology Development Co., Ltd., Beijing (CN)

(72) Inventors: Junchao Yu, Beijing (CN); Chenyu Tian, Beijing (CN); Tongyu Dai, Beijing (CN); Thomas Howe, Chicago, IL (US)

(73) Assignees: Disney Enterprises, Inc., Burbank, CA (US); Beijing YoJaJa Software Technology Development Co., Ltd., Beijing (CN)

(21) Appl. No.: 19/030,380

(22) Filed: Jan. 17, 2025

(51) Int. Cl. G06F 11/07

(52) U.S. Cl. CPC G06F 11/079; G06F 11/0721

(57) ABSTRACT

In some embodiments, a method receives online quality of service (QoS) metric values for online logs of using a service. Synthetic QoS metric values that describe anomalies are added to the training dataset. A model predicts predicted QoS metric values in the online logs. A distribution of a difference between QoS metric values from the training dataset and the predicted QoS metric values is determined. The method uses the difference to adjust a parameter in the model to train the model to predict the predicted QoS metric values. The distribution is used to determine a dynamic threshold that is used to determine whether an anomaly occurs. The method determines whether an anomaly is detected in new online logs based on applying the dynamic threshold to a difference between online QoS metric values and predicted QoS metric values generated by the trained model. The dynamic threshold changes over the time series.

### BACKGROUND

A system may employ an anomaly detection process to detect anomalies in data. It may be important to detect anomalies in real time such that any possible remedial actions can be performed as soon as possible. In some examples, a content delivery system may receive quality of service (QoS) data from different entities that are delivering content, such as content delivery networks and/or Internet Service Providers. However, it may be difficult to analyze the data for anomalies. For example, training a model to analyze the data may not address data drift, seasonality challenges, or be fast enough. In some examples, data may drift over time, which may require a new complete set of data in bulk to re-train the model. Also, seasonality may occur where different patterns may be experienced, which requires the model to be retrained again with a new batch of training data. The above training may slow down the process of detecting anomalies and cause a lag in the detection based on the retraining process.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system of a content delivery system according to some embodiments.

FIG. 2 depicts a more detailed example of an anomaly detection system according to some embodiments.

FIG. 3 depicts a simplified flowchart of a method for training a model according to some embodiments.

FIG. 4 depicts a simplified flowchart of a method for performing the inference stage according to some embodiments.

FIG. 5 depicts a graph that shows an anomaly according to some embodiments.

FIG. 6 illustrates one example of a computing device according to some embodiments.

### DETAILED DESCRIPTION

Described herein are techniques for an anomaly detection system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system performs anomaly detection of data. In some examples, the system may operate a content delivery system that delivers content to client devices. The data that is monitored for anomalies may be based on the delivery of the content, such as quality of service (QoS) data that measures the quality of service while delivering content to client devices. However, the anomaly detection process may be used to prevent and detect anomalies for any system issues that may occur in different fields, such as network security, platform health monitoring, industrial Internet of things (IoT), user experience and management, etc.

The anomaly detection may detect anomalies in the data quickly, which allows a root cause of an issue to be identified and the issue to be addressed promptly. This may ensure a superior viewing experience at client devices as issues are resolved. In some examples, the system may operate in hundreds of geographical regions over numerous delivery entities, such as content delivery networks (CDNs), and Internet Service Providers (ISPs), that stream thousands of different content instances. The anomaly detection process needs to be scalable to monitor and track different quality of service metrics that can detect anomalies in real-time at a large number of entities.

A system may experience anomaly incidences on an infrequent basis. That is, the samples that can be determined from historical data may be sparse for a long time, and there may be very few incidence samples of anomalies. When testing the anomaly detection system on the historical data, the verification of the effectiveness of the anomaly detection system may be hard. To overcome this problem, the anomaly detection system may generate synthetic data to simulate anomaly incidences. The synthetic data may be based on the characteristics of incidences in the historical data to supplement the anomalies in the historical data. The synthetic data may be generated based on the values of the anomalies mostly conforming to a distribution, such as a normal distribution. The synthetic anomalies may be generated based on characteristics that follow the distribution. Generating synthetic data may be challenging because the amount of data that needs to be analyzed for sparsely defined incidences is large and it is hard to find the incidences.

The anomaly detection engine may use a domain specific language to describe characteristics of a certain type of incidence that may occur. The language may define the sample's time range, spatial dimension, anomaly type, anomaly intensity, and other characteristics. These characteristics may then be used to detect anomalies in the dataset. The correlation between indirect operations at each session level and direct data generation at the metrics level may be observed. By upgrading the operations at the session level to direct operations on metrics, the speed of synthetic data sample generation is accelerated. Suppose there are four playback sessions in one minute, and their Video Start Time (VST) are 0.1, 0.2, 0.3, and 0.4 seconds respectively. Then the overall video start time for this minute is (0.1+0.2+0.3+0.4+0.5)/5=0.25. Since the amount of session data is very large, the anomaly is detected based on the metric of 0.25. Using multiple metrics from the sessions requires operating a large amount of data and takes a long time. Therefore, simulating an anomaly directly on the metric increases the speed of generating synthetic data without causing simulation distortion.

The anomaly detection engine uses a model that is trained to predict metrics, which may be considered expected, normal, or a baseline. The anomaly detection engine includes a classifier to detect and classify anomalies. The model may use a percentile classifier based on the concept of a distribution. A distribution using the differences between the predicted value and the ground truth value is determined. Then, the system selects a threshold based on a percentile difference value in the distribution, such as the difference value that corresponds to the top 3% quantile as the threshold to determine an anomaly. This threshold may be designed to capture 97% of the distribution of anomalies. The anomaly detection engine may filter out anomalies in the data using filter, such as a queue filter. For example, a queue is used to determine when a number of anomalies are detected over time samples, and then an alert may be issued. Thus, the anomalies that are detected may not cause false alarms due to excessive sensitivity using the queue filter.

In some embodiments, the model is trained based on seasonality parameters. Here, the model is able to adapt to seasonal changes in the service when predicting time series data. This may improve the anomaly detection as the model may automatically adjust to seasonality when predicting the time series data.

### System

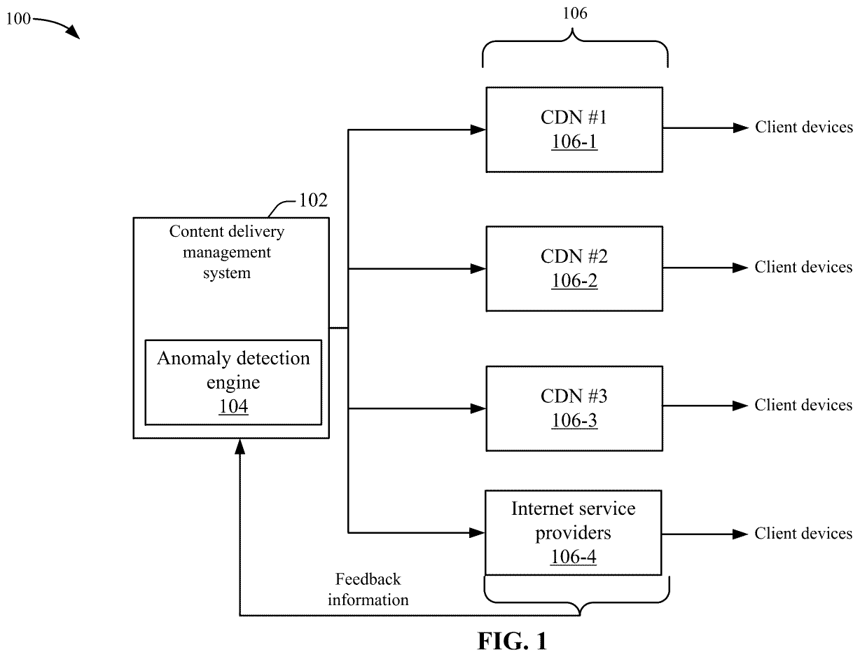

FIG. 1 depicts a simplified system 100 of a content delivery system according to some embodiments. System 100 includes content delivery management system 102 and delivery entities 106. Delivery entities 106 may include networks that deliver data, such as content delivery networks (CDNs) 106-1 to 106-N, Internet Service Providers (ISPs) 106-4, or other delivery networks. The data may be content, such as videos, audio, etc. Content delivery management system 102 may include computing devices that may coordinate the delivery of content to client devices, such as requests for content are received, and the requests are sent to delivery entities 106, which deliver the content to the client devices. As mentioned above, the anomaly detection process may be used in fields other than content delivery, but content delivery will be used as an example. In other fields, the data that is analyzed may be different based on the service being provided. For example, network security may analyze requests for data being processed by a network for anomalies.

Feedback information may be received over time, which may be referred to as a time series of data. For example, content delivery management system 102 may receive data and generate time series data sets for every second, minute, hour, or any other granularity. Each data set may be associated with a time in the time series. For example, data may be continuously received, and content delivery management system 102 may generate samples of data for each minute from the data received in the last minute. This process occurs for each minute to create samples of data for each minute. The time series data that is created may be based on quality of service metrics, which will be described below.

An anomaly detection engine 104 may use a model that predicts expected values in time series data and a classifier that detects anomalies in predicted time series data. In some embodiments, the time series data is quality of service metrics that are based on the delivery of content from delivery entities 106 to client devices. The model receives values for features of the sessions, and predicts the expected values for the metrics. Then, anomaly detection engine 104 determines a difference between the predicted values and the time series data received from delivery entities 106, and detects anomalies when the differences meet a threshold.

Anomaly detection engine 104 may detect an anomaly based on multiple dimensions. The following discussion will give examples of dimensions, such as partner, region, and platform, but other dimensions may be appreciated. The partner may be the delivery entity that delivers the content, the region may be the location area in which the content is delivered, and the platform may be the platform that is used during the delivery process. Anomaly detection system will now be described in more detail.

Anomaly detection engine 104 may output the anomalies that are detected. For example, anomaly detection engine 104 may output different times in the time series and the features in which an anomaly is detected. Then, content delivery management system 102 may perform an action to resolve any problems that have been occurring. The anomaly may be caused by different root causes, which may be determined. For example, the action may be to determine acceptable ranges of values for the features, and send the ranges to a delivery entity 106 with a notification of the problem. Also, anomaly detection engine 104 may also troubleshoot an issue associated with the anomaly.

The following will now describe the anomaly detection process in more detail.

### Anomaly Detection System

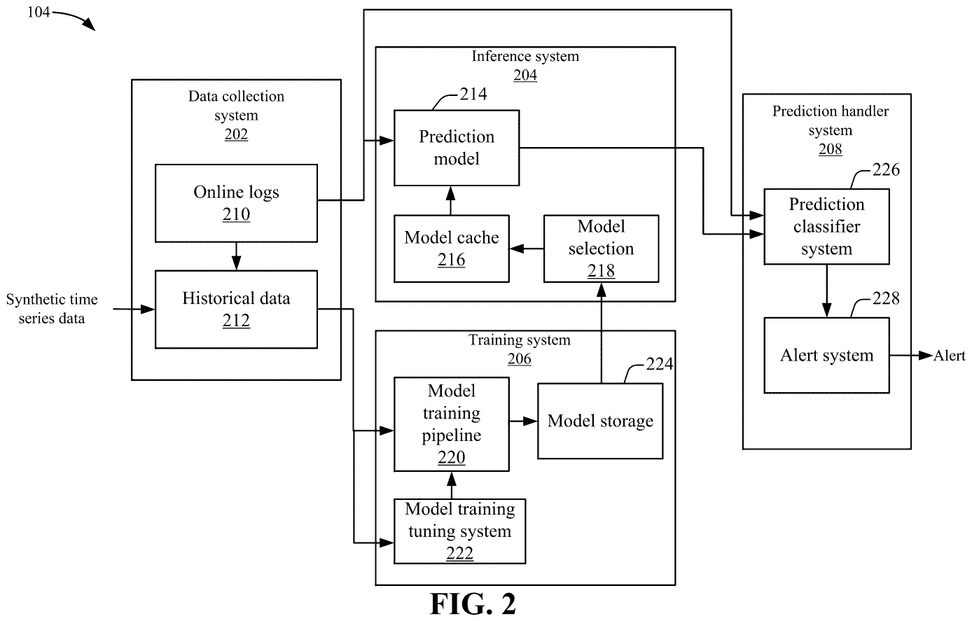

FIG. 2 depicts a more detailed example of anomaly detection system 104 according to some embodiments. Anomaly detection engine 104 includes a data collection system 202, an inference system 204, a training system 206, and a prediction handler system 208.

Data collection system 202 may collect data that may be used by inference system 204 or training system 206. In some embodiments, the data collected may be online logs at 210 and historical data at 212. The online logs may be feedback that is received based on client devices that are playing back content from delivery entities 106. The online logs may form time series data, which may be data over a time period. The online logs may also be logs of other online information, such as websites that are viewed, selections of products, etc. Additionally, if data other than content delivery data is being analyzed, the logs may be different.

Historical data may include data that is from past online logs. Additionally, the historical data may include synthetic time series data. The synthetic time series data may be data in which anomalies may be synthesized. The anomalies may be synthesized to make historical data more robust for training. As mentioned above, the anomalies in the online logs may be sparse and the synthetic time series data may supplement the anomalies in the online logs. The synthetic time series data may not be used for inference.

Data collection system 202 may receive the logs and convert them into metrics, such as quality of service (QoS) metrics for the playback. The conversion may take events that occur in the online logs, such as startup times, playing times, seeking times, buffering, pauses, etc., and determine metrics from the events. Some metrics that may be used to measure the quality of service for the playback may include connection-induced rebuffer ratio (CIRR), video playback failure (VPF), video startup failure (VSF), and video startup time (VST). Connection-induced rebuffer ratio may evaluate the quality of video content delivery by measuring the occurrence of rebuffering events during video playback that are caused by connection issues. Rebuffering happens when the playback is interrupted due to buffering delays caused by insufficient network bandwidth or other connection-related problems.

Video playback failure represents the failure rate of video playback attempts. The video playback failure metric measures the percentage of playback attempts that result in failures, such as buffering issues, playback interruptions, or playback errors. A lower value indicates a higher quality where fewer video playback failures result and the video playback experience is more seamless without interruptions.

The video start failure metric measures the failure rate of video start attempts. The metric indicates the percentage of attempts to start playing a video that fail due to various issues, such as long buffering times, playback errors or network connectivity problems. Similar to the video playback failure metric, a lower video start value indicates less video start failures and a better content delivery experience at the initial stage of playback.

The video start time metric represents the time takes for a video to start playing after a playback is started at a client device. The metric measures the delay between the user's action to start playing a video and the actual playback start. A lower video start time value reflects a faster video start time and a more responsive service.

Training system 206 may train models that may be used. A single model may be discussed, but multiple models may be appreciated. For example, there may be a model for each of the metrics. Model training tuning system 222 may explore parameter settings for the model to optimize the parameters. Model training tuning system 222 may determine the training process to be used by model training pipeline 220. For example, model training tuning system 222 may determine what metric values constitute an anomaly and what metric values constitute normal behavior. Model training tuning system 222 may analyze the historical data and determine portions of the historical data that define anomalies and portions that define normal operation. The anomalies may be found in the data from the online logs and also from the synthetic data.

Model training pipeline 220 may receive input of features and output predictions based on the values of the parameters of the model. The input may be time series data for metrics, such as a video startup time of 2.4 seconds at a time of 10:25. The output may be a prediction of quality of service metrics in a time series. For example, if a prediction of for the time period of 2024.10.01-2024.10.07 (October 1, 2024 to October 7, 2024) is desired, the input may be the data for the metric being predicted from the time period before the desired prediction time range, such as the time period of 2024.08.01-2024.09.30.

Model training tuning system 222 may compare the prediction with the ground truth to further tune the parameters. For example, the model may receive features for the time series data, and output a prediction of a metric, such as connection induced rebuffer ratio. The predicted metric value is compared to the ground truth to determine differences. Then, model training tuning system 222 may adjust the parameters to minimize the differences. In some embodiments, different combinations of parameter values may be tested and the combination that minimized the differences may be selected. In other embodiments, the training may adjust parameter values. As will be discussed in more detail below, model training tuning system 222 may train parameters that are associated with seasonality. The seasonality may be parameters that adjust the analysis of time series data based on different time periods in the calendar year. The training trains the model to output expected values for quality of service metrics that takes into account seasonality.

A model storage 224 may store the trained models, such as the parameter values for the trained models. Each model that is trained may be stored in model storage 224.

Once the models are trained, inference system 204 may perform predictions using online logs that are received for current playback sessions. The prediction may be performed in real-time as online logs are received. A model selection 218 may select a model, such as a model to predict connection induced rebuffer ratio. Then, the model may be loaded from a model cache 216 as prediction model 214. Prediction model 214 may then receive input features for the online logs that are received in a time series and output a prediction for the metric. For example, the input may be metric values (e.g., video start up time) for a time series for a first time period. The prediction may be a time series of values that represents the metric value over time after the first time period.

Prediction handler system 208 may use the predictions to generate alerts. For example, a prediction classifier system 226 may analyze the prediction to determine when an anomaly is detected in time samples. In some embodiments, prediction classifier system 226 may compare the predicted metric values to the actual values from the online logs. Prediction classifier system 226 may use a threshold that is determined during training to detect when an anomaly is detected. For example, when the difference meets a threshold (e.g., exceeds a threshold), prediction classifier system 226 determines an anomaly occurred during this time period. Prediction classifier system 226 may analyze multiple time periods and output multiple indications of whether an anomaly is detected. For example, the time periods may include data from every second, five seconds, ten seconds, etc.

In some embodiments, prediction classifier system 226 uses a queue to filter some anomalies to limit false alarms (e.g., small spikes in data may be anomalous, but may not warrant generating an alert because the data returns to normal quickly). The queue may be used to cache the most recent predictions. When a number of anomalies that are detected exceeds a certain proportion of anomalies in the queue, prediction analysis system 226 may issue an alert to alert system 228. This ensures that the vast majority of alerts generated by prediction handler system 208 may be real anomalies that are detected, and not fluctuations that may be false alarms. Other noise reduction processes may also be used to filter out anomalies.

Alert system 228 may receive a signal from prediction analysis system 226 when an anomaly is determined, and then process the alert. Alert system 228 may perform different actions, such as outputting different alerts including an email notification, message, phone call, etc. Also, alert system 228 may also automatically take an action in response to the anomaly. For example, alert system 228 may perform an action on the network if an anomaly is detected, such as taking down a node, quarantining network traffic, etc.

The following will now describe the training stage in more detail, and then the inference stage will be described.

### Training Stage

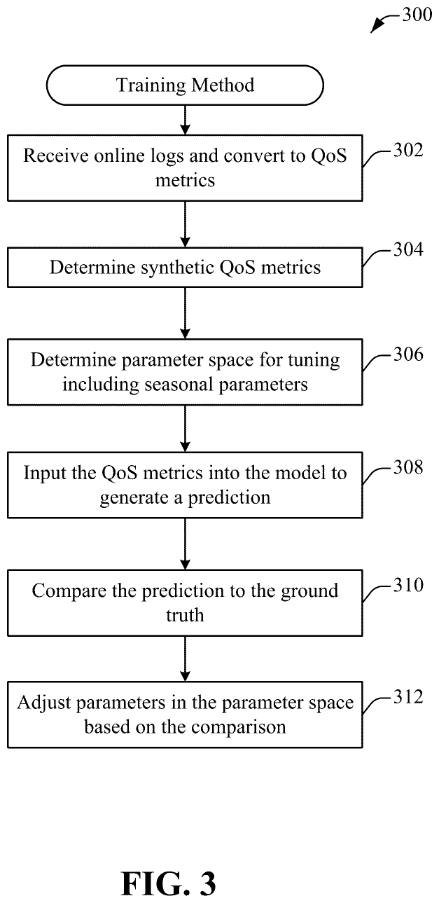

FIG. 3 depicts a simplified flowchart 300 of a method for training a model according to some embodiments. At 302, online logs are received and converted to quality of service metrics. As discussed above, the events that occur in the online logs may be converted into quality of service metrics, such as connection-induced rebuffed ratio, video playback failure metrics, video start failure metrics, and video start time metrics.

At 304, synthetic quality of service metrics are determined. The quality of service metrics from the online logs may have anomaly samples, but the occurrence of anomalies may be sparse in the time series data. Data collection system 202 may analyze the characteristics of the quality of service metrics, such as the anomalies that are determined to occur in the quality of service metrics. Then, data collection system 202 may generate synthetic quality of service metrics that may include anomalies. A domain-specific language may describe the characteristics of a certain type of anomaly that may occur. The language defines the anomaly sample's time range (e.g., start time and end time), spatial dimension (e.g., location, platform, etc.), anomaly type, and anomaly intensity (e.g., type of anomaly and values) as calculated based on the quality of service metrics from the online logs. By observing the real anomalies in history, the anomalies may conform to the characteristics of a distribution, such as a normal distribution. Then, data collection system 202 may use a normal distribution to generate anomalies. For example, if there are five minutes of data with the values of 4, 5, 3, 4, 3, data collection system 202 will use Gaussian distribution to generate five data points, 1, 2, 6, 2, 1, and then randomly shuffle them, and then linearly add them to the existing metric as synthetic data.

At 306, training system 206 determines a parameter space for tuning. The parameter space may include seasonal features. For example, training system 206 may set seasonality parameters to be used. Examples of seasonality parameters include daily seasonality, weekly seasonality, yearly seasonality, and holidays. The daily seasonality may observe seasonality daily in the time series data, such as evenings may be busier than during the day when downloading videos. Weekly seasonality may be seasonality that experienced on a weekly basis and the time series data, such as for weekends, may be adjusted. Yearly seasonality may be where seasonality experienced yearly in the time series data, such as summer months may be busier. In some examples, the service may be offered around the world in different countries, and holidays may be very different in different countries. The holiday parameter seasonality may not be used in this case.

Using the seasonality parameters, the prediction model may take into account the influence of seasonality, such as data characteristics brought by an increase in the usage of the service during the weekend. In some embodiments, the interest in usage may increase linearly, and the growth parameter may be set to linear for growth, and also an additive seasonality mode may be used where the increase may be additive. Other parameter settings may also be used.

At 308, training system 206 inputs features for the historical data into the model to generate a prediction. As discussed above, the input may be metric values for a time period. In some embodiments, for time series data, the prediction model may output a time series of predictions, which may be multiple predictions for multiple time periods (e.g., every second, minute, hour, etc.) for a quality of service metric. The model may include parameters that are set as defined in 306.

At 310, training system 206 compares the prediction to the ground truth. For example, the prediction may be metric values for a time period and the ground truth may be the actual historical data. The prediction metric values are compared to the metric values in the ground truth in corresponding time periods. The comparison may yield differences for the time period. Then, at 312, training system 206 adjusts parameters in the parameter space based on the comparison. For example, the parameters may be adjusted to minimize the differences.

Training system 206 may have generated quality of service metrics that had unnecessary noise that interfered with the training process and led to inaccurate predictions. For example, the metric value may occasionally have a value that is beyond the normal range, but this may be just noise, not a true anomaly. Therefore, a filter after the model output may be used such that when the continuous output anomaly exceeds a certain proportion, it is considered an anomaly. For example, an anomaly may be determined only when there are more than four anomalies in five consecutive prediction values (e.g., 80%). A single value may be ignore as an anomaly.

Anomaly detection may be a classification problem where an anomaly is detected or not detected. The differences between the actual values and the predicted values may conform to a distribution, such as a normal distribution. For example, the difference for values that are predicted for the connection induced rebuffer ratio, video startup time, video startup failure, and video playback failure and the actual values in the historical data may be measured and may conform to a distribution.

An anomaly threshold may be set based on the distribution that is observed during training. The threshold is then used by prediction classifier system 226 to detect anomalies. In the training process, different levels of thresholds may be applied based on the distribution to determine a threshold that can be used to detect anomalies. For example, training system 206 may test different thresholds based on percentiles of the distribution to determine which threshold is optimal to detect anomalies with respect to precision and recall. For example, selecting a threshold of the top 1% of the distribution may yield anomalies with a high precision, but with lower recall. That is, the anomalies that are detected may most likely be true (higher precision), but other anomalies may not be detected (lower recall). Here, the threshold may be higher where a larger difference is required to determine an anomaly. A lower percentile of the distribution may correspond to a lower threshold, where smaller differences may be considered anomalies thereby detecting more anomalies, but some of the anomalies may be false positives. In some embodiments, training system 106 attempts to find a threshold with the recall of 100% and the highest precision. The use of the distribution may be different from using a fixed threshold. For example, a fixed threshold may be set based on a baseline of predicted values. The threshold from the distribution may not be fixed because the threshold may vary based on the predicted values.

The threshold may be used to detect anomalies. For example, when the data being analyzed violates the threshold, then an anomaly may be detected. The threshold may be dynamic and changes based on time. As discussed above, the model predicts values based on seasonal characteristics, and since the threshold is a difference value from the predicted value, the threshold may change based on the season. In some examples, the threshold may be a difference between a predicted value of a metric (CIRR) and the actual metric, where an anomaly occurs when the difference meets the threshold (e.g., is larger).

Once the model is trained, the inference stage may use the trained model.

### Inference Stage

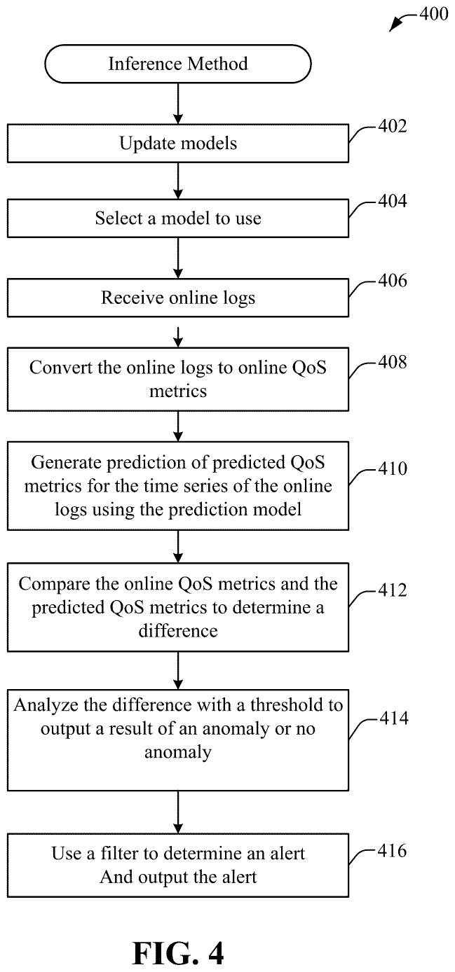

FIG. 4 depicts a simplified flowchart 400 of a method for performing the inference stage according to some embodiments. At 402, inference system 204 updates the prediction model being used. For example, prediction models may be updated periodically.

At 404, inference system 204 selects a model to use. The model to use may be based on different quality of service metrics, such as a model to predict the connection-induced rebuffering ratio, video startup time, etc. may be selected.

At 406, data collection system 202 receives online logs. The online logs may be for a time period in a time series. For example, real-time online logs may be received and added to data that has been received for the last hour, day, week, etc.

At 408, data collection system 202 converts the online logs to quality of service metrics. For example, the quality of service metrics may include connection-induced rebuffer ratio, video playback failures, etc. over a time series.

At 410, prediction model 214 generates prediction of the quality of service metrics for the time series of the online logs used. For example, if connection-induced rebuffering ratio is being used, the value for the connection induced rebuffering ratio is generated for the time series on online logs. The feature values for the online logs may be input into prediction model 214, and the output is predicted values for the quality of service metrics. As discussed above, the prediction takes into account seasonality when predicting the quality of service metrics.

At 412, prediction analysis system 226 compares the online quality of service metrics and the predicted quality of service metrics to determine a difference. For example, the difference may be determined for multiple samples in the time series of data.

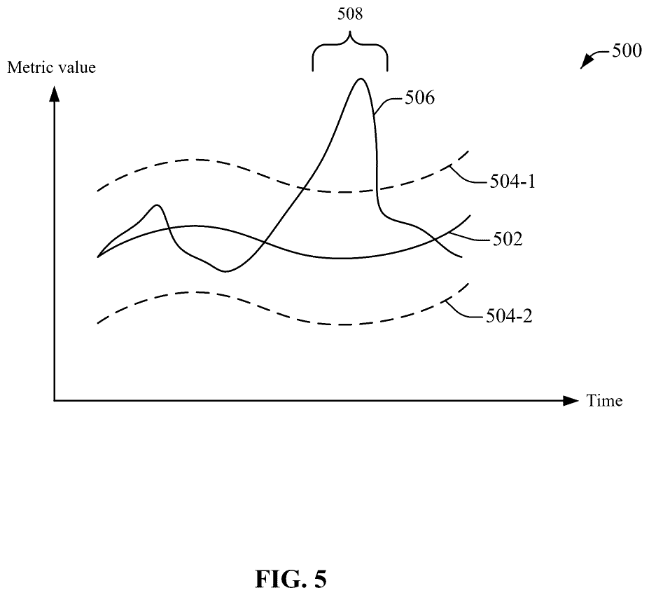

At 414, prediction analysis system 226 analyzes the differences against a threshold to output a result of an anomaly or no anomaly for the samples. For example, when the threshold is violated for a time sample, prediction analysis system 226 determines an anomaly is detected for that time sample. Also, when the threshold is not violated, prediction analysis system 226 determines no anomaly is detected. In some embodiments, the threshold may be violated when the difference is greater than the threshold. Prediction analysis system 226 may output multiple indications of when an anomaly is detected. For example, a time period in which the online quality of service metrics violates the threshold maybe be output as the result, such as the anomaly may be detected from a time 1:00 pm to 1:06 pm. FIG. 5 depicts a graph 500 that shows an anomaly according to some embodiments. At 502, a predicted metric time series is shown. At 506, the real metric values are shown. A threshold is shown at 504-1 and 504-2. The threshold may vary with the values of the predicted metric time series. At 508, when the real metric values violate the threshold, prediction analysis system 226 generates an anomaly.

At 416, prediction analysis system 226 analyzes the results using a filter to determine when to output an alert, and outputs the alert when determined. For example, a queue filter may be used to determine when an alert should be detected. Anomalies that are detected may be detected for certain time samples, such as in 1 second or 10 second intervals. If a proportion of anomalies are detected in the queue, then an alert may be generated. For example, if a certain number of samples out of the total number of samples in the queue indicates that an anomaly has occurred, then prediction analysis system 226 generates an alert. This ensures that alerts that are generated due to small fluctuations in the online quality of service metrics may not trigger alerts. However, real problems that are being experienced may be triggered as an alert.

When determined, alert system 228 outputs the alert. The alert may indicate an anomaly is determined. Also, the alert may be used to address a root cause of the anomaly. The alert may be used to perform an action for the service. The action may change an aspect of the service, such as in the delivery of content. For example, the anomaly may trigger an analysis of the sessions'data with more dimensions to find the root causes. For example, if the issue mainly happened in a specific platform, such as with a cellular phone type or living room device, the system locates whether the anomaly is related to some devices, an operating system, or an application/media player version. After the system locates the root cause, the system will take actions based on the root causes. In some example cases, if the issue was related to the specific events, the system may scale the service ability, such as reduce throughput. If the issue is associated with some specific media source, the system may check the video encoding process. If the issue is associated with the client, the system may check the newest version, determine a fix, and release fix to the version.

### Conclusion

Accordingly, an improved anomaly detection system is provided. The prediction model may take into account seasonality to adjust the prediction of the quality of service metrics. This allows the prediction to follow seasonality patterns. Also, the threshold that is used may be dynamically adjusted based on the predicted quality of service metrics. This allows anomalies to be detected more precisely with less false alarms compared to using a static threshold.

### System

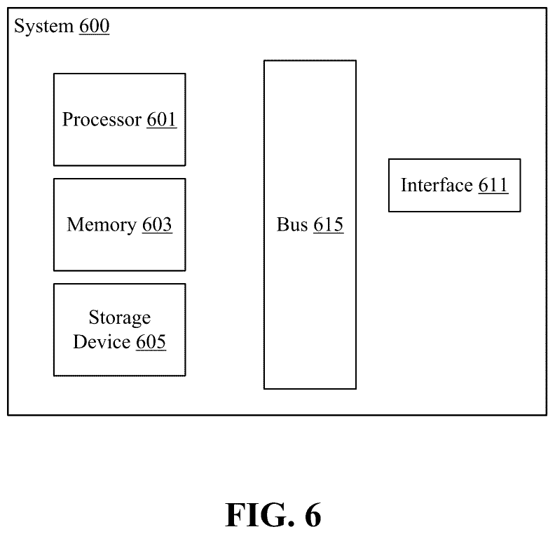

FIG. 6 illustrates one example of a computing device according to some embodiments. According to various embodiments, a system 600 suitable for implementing embodiments described herein includes a processor 601, a memory 603, a storage device 605, an interface 611, and a bus 615 (e.g., a PCI bus or other interconnection fabric.) System 600 may operate as a variety of devices such as anomaly detection engine 104, or any other device or service described herein. Although a particular configuration is described, a variety of alternative configurations are possible. Processor 601 may perform operations such as those described herein. Instructions for performing such operations may be embodied in memory 603, on one or more non-transitory computer readable media, or on some other storage device. Various specially configured devices can also be used in place of or in addition to processor 601. Memory 603 may be random access memory (RAM) or other dynamic storage devices. Storage device 605 may include a non-transitory computer-readable storage medium holding information, instructions, or some combination thereof, for example instructions that when executed by the processor 601, cause processor 601 to be configured or operable to perform one or more operations of a method as described herein. Bus 615 or other communication components may support communication of information within system 600. The interface 611 may be connected to bus 615 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving online quality of service metric values for online logs of using a service, wherein the online quality of service metric values are included in a training dataset;
determining synthetic quality of service metric values that describe anomalies, wherein the synthetic quality of service metric values are added to the training dataset;
predicting, using a model, predicted quality of service metric values for the online logs;
determining a distribution of a difference between quality of service metric values from the training dataset and the predicted quality of service metric values;
using the difference to adjust a parameter in the model to train the model to predict the predicted quality of service metric values;
using the distribution to determine a dynamic threshold that is used to determine whether an anomaly occurs; and
determining whether an anomaly is detected in new online logs based on applying the dynamic threshold to a difference between a time series of online quality of service metric values and predicted quality of service metric values generated by the trained model, wherein the dynamic threshold changes over the time series.

2. The method of claim 1, wherein determining synthetic quality of service metric values comprises:
analyzing characteristics of an online anomaly in the online quality of service metric values; and
using the characteristics to generate a synthetic anomaly in the training dataset.

3. The method of claim 2, wherein the synthetic anomaly includes different characteristics from the online anomaly.

4. The method of claim 3, wherein the different characteristics are described using a predefined language.

5. The method of claim 3, wherein the different characteristics are determined based on the synthetic anomaly following a distribution of differences.

6. The method of claim 1, wherein receiving the online quality of service metric values for online logs comprises:
receiving feedback from delivering content to client devices; and
determining the online quality of service metric values from events in the feedback.

7. The method of claim 1, wherein predicting, using the model, predicted quality of service metric values comprises:
inputting feature values for the online logs into the model, wherein the model outputs the predicted quality of service metric values based on parameter values of the model.

8. The method of claim 1, wherein determining the distribution comprises:
determining differences for multiple samples of the quality of service metric values from the training dataset and the predicted quality of service metric values; and
forming the distribution from the differences.

9. The method of claim 1, wherein using the difference to adjust the parameter in the model comprises:
adjusting the parameter to minimize the difference.

10. The method of claim 1, wherein using the distribution to determine the dynamic threshold comprises:
selecting different thresholds to classify the differences as anomalies; and
analyzing the anomalies that are classified based on a ground truth of anomalies to select one of the thresholds.

11. The method of claim 10, wherein the threshold is selected based on a combination of recall and precision in detecting anomalies.

12. The method of claim 10, wherein:
the different thresholds that are selected are based on percentile values in the distribution, and
the percentile values correspond to differences between the quality of service metric values from the training dataset and the predicted quality of service metric values.

13. The method of claim 1, wherein the parameter comprises a seasonal parameter that adjusted the predicted quality of service metric values based on seasonal characteristics.

14. The method of claim 1, wherein determining whether anomalies are detected in new online logs comprises:
predicting, using the trained model, predicted quality of service metric values for the new online logs;
determining a difference between the online quality of service metric values from the new online logs and the predicted quality of service metric values; and
applying the difference to the dynamic threshold to detect an anomaly.

15. The method of claim 14, wherein determining whether anomalies are detected in new online logs comprises:
receiving a plurality of detected anomalies in a plurality of samples;
determining whether the plurality of detected anomalies meets a condition; and
detecting an anomaly when the condition is met.

16. The method of claim 1, further comprising:
outputting an alert based on the anomaly being detected.

17. The method of claim 16, further comprising:
performing an action to address the anomaly for the service.

18. A non-transitory computer-readable storage medium having stored thereon computer executable instructions, which when executed by a computing device, cause the computing device to be operable for:
receiving online quality of service metric values for online logs of using a service, wherein the online quality of service metric values are included in a training dataset;
determining synthetic quality of service metric values that describe anomalies, wherein the synthetic quality of service metric values are added to the training dataset;
predicting, using a model, predicted quality of service metric values for the online logs;
determining a distribution of a difference between quality of service metric values from the training dataset and the predicted quality of service metric values;
using the difference to adjust a parameter in the model to train the model to predict the predicted quality of service metric values;
using the distribution to determine a dynamic threshold that is used to determine whether an anomaly occurs; and
determining whether an anomaly is detected in new online logs based on applying the dynamic threshold to a difference between a time series of online quality of service metric values and predicted quality of service metric values generated by the trained model, wherein the dynamic threshold changes over the time series.

19. The non-transitory computer-readable storage medium of claim 18, wherein determining synthetic quality of service metric values comprises:
analyzing characteristics of an online anomaly in the online quality of service metric values; and
using the characteristics to generate a synthetic anomaly in the training dataset.

20. An apparatus comprising:
one or more computer processors; and
a computer-readable storage medium comprising instructions for controlling the one or more computer processors to be operable for:
receiving online quality of service metric values for online logs of using a service, wherein the online quality of service metric values are included in a training dataset;
determining synthetic quality of service metric values that describe anomalies, wherein the synthetic quality of service metric values are added to the training dataset;
predicting, using a model, predicted quality of service metric values for the online logs;
determining a distribution of a difference between quality of service metric values from the training dataset and the predicted quality of service metric values;
using the difference to adjust a parameter in the model to train the model to predict the predicted quality of service metric values;
using the distribution to determine a dynamic threshold that is used to determine whether an anomaly occurs; and
determining whether an anomaly is detected in new online logs based on applying the dynamic threshold to a difference between a time series of online quality of service metric values and predicted quality of service metric values generated by the trained model, wherein the dynamic threshold changes over the time series.
